(19) United States
(12) Patent Application Publication
(10) Pub. No.: US 2019/0172664 A1
(43) Pub. Date: Jun. 6, 2019

(54) KEYBOARD STRUCTURE

(71) Applicant: Primax Electronics Ltd., Taipei (TW)

(72) Inventors: Bo-An Chen, Taipei (TW); Yu-Ming Lin, Taipei (TW)

(21) Appl. No.: 16/189,748

(22) Filed: Nov. 13, 2018

(30) Foreign Application Priority Data
Dec. 1, 2017 (TW) 106142221

(51) Int. Cl. H01H 13/83; H01H 13/88

(52) U.S. Cl. CPC H01H 13/83; H01H 13/88; H01H 2209/082; H01H 2229/044; H01H 2221/0702; H01H 2219/03

(57) ABSTRACT

The present invention provides a keyboard structure, including: a keycap, having an upper surface and a lower surface; a support plate; and a support component, configured to connect to the keycap and the support plate, where the upper surface includes a non-transparent three-dimensional character layer and a transparent protective layer coating the non-transparent three-dimensional character layer.

### FIELD OF THE INVENTION

The present invention relates to an input device, and in particular, to a keyboard structure.

### BACKGROUND OF THE INVENTION

In modern society, electronic products have become an indispensable part in life, and each aspect of food, clothing, housing, transportation, education, and entertainment is related to the electronic products. Usually, an electronic product is equipped with a keyboard structure. To make characters on keycaps of the keyboard structure clearer, in the existing technology, such as Chinese Patent Announcement No.CN101515514B, a method for manufacturing a key having a three-dimensional pattern is provided. Referring to FIG. 5, in FIG. 5, a pattern layer 12 having a three-dimensional pattern 121 is formed by using an ultraviolet light curing resin (UV-curing resin), then a keycap layer 14 is formed on the pattern layer 12 by using the UV-curing resin, and the keycap layer 12 has a keycap 141 coating the three-dimensional pattern 121. However, because the three-dimensional pattern 121 and the keycap 141 are both transparent structures formed by the UV-curing resin, a backlight source needs to provide light to penetrate the three-dimensional pattern 121 and the keycap 141, so that the characters of the three-dimensional pattern 121 have a three-dimensional visual effect. In a case of absence of the backlight source, the three-dimensional visual effect of the characters is not prominent.

Therefore, to make the characters of the keyboard have the three-dimensional visual effect in a case of no penetration of the backlight source is a technical problem to be resolved in the present invention.

### SUMMARY OF THE INVENTION

A main objective of the present invention is to provide a keyboard structure and to make a character of a keycap have a three-dimensional visual effect in a case of no penetration of a backlight source.

To achieve the foregoing objective, the present invention provides a keyboard structure, including:

a keycap, having an upper surface and a lower surface;

a support plate; and

a support component, configured to connect to the keycap and the support plate, where

the upper surface includes a non-transparent three-dimensional character layer and a transparent protective layer coating the non-transparent three-dimensional character layer.

In the foregoing preferred implementations, the thickness of the transparent protective layer is equal to the thickness of the non-transparent three-dimensional character layer, so that the non-transparent three-dimensional character layer and the transparent protective layer form a coplane.

In the foregoing preferred implementations, the non-transparent three-dimensional character layer includes a first three-dimensional character layer and a second three-dimensional character layer.

In the foregoing preferred implementations, the thickness of the first three-dimensional character layer is equal to the thickness of the second three-dimensional character layer.

In the foregoing preferred implementations, the thickness of the first three-dimensional character layer is greater than the thickness of the second three-dimensional character layer.

In the foregoing preferred implementations, the thickness of the first three-dimensional character layer is less than the thickness of the second three-dimensional character layer.

In the foregoing preferred implementations, the material of the non-transparent three-dimensional character layer is rubber or silica gel.

In the foregoing preferred implementations, the material of the transparent protective layer is a UV curing adhesive, acryl, or transparent silica gel.

In the foregoing preferred implementations, an elastic component is disposed between the keycap and the support plate, and the support component encircles the elastic component.

In the foregoing preferred implementations, a thin film layer is disposed on the support plate, the thin film layer includes at least one switch, and the at least one switch corresponds to the elastic component.

In the foregoing preferred implementations, the material of the elastic component is rubber, silica gel, or a metal elastic piece.

A preferred practice of the present invention relates to a method for forming a keycap three-dimensional character, including the following steps:

(a) providing a keycap;

(b) forming a non-transparent three-dimensional character layer on an upper surface of the keycap; and

(c) forming on the upper surface of the keycap a transparent protective layer coating the non-transparent three-dimensional character layer.

In the foregoing preferred implementations, in step (b), the non-transparent three-dimensional character layer includes a first three-dimensional character layer and a second three-dimensional character layer.

In the foregoing preferred implementations, in step (b), the material of the non-transparent three-dimensional character layer is rubber or silica gel.

In the foregoing preferred implementations, in step (c), the material of the transparent protective layer is a UV curing adhesive, acryl, or transparent silica gel.

### BRIEF DESCRIPTION OF THE DRAWINGS

FIG. 1 is a flowchart of forming a keycap three-dimensional character according to the present invention;

FIG. 2A is a schematic diagram of a first implementation of a process of forming a keycap three-dimensional character according to the present invention;

FIG. 2B is a schematic diagram of a second implementation of a process of forming a keycap three-dimensional character according to the present invention;

FIG. 3 is a schematic three-dimensional diagram of a keyboard structure according to the present invention;

FIG. 4A is a sectional view of the first implementation of a keyboard structure according to the present invention;

FIG. 4B is a sectional view of the second implementation of a keyboard structure according to the present invention; and

FIG. 5 is a sectional view of a three-dimensional character structure of a keyboard in the existing technology.

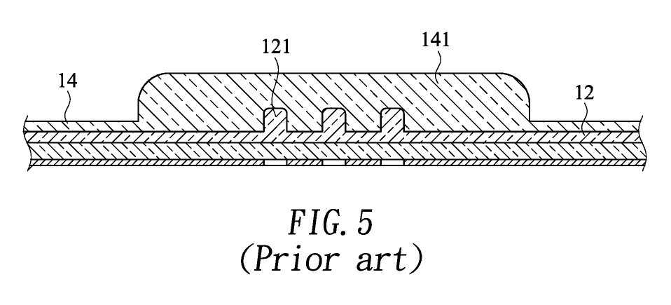

### DETAILED DESCRIPTION OF THE PREFERRED EMBODIMENT

Advantages and features of the present invention and achievement of a method thereof are more easily understood by being described in more detail with reference to exemplary embodiments and accompanying drawings. However, the present invention may be implemented in different forms and should not be understood as merely being limited to the embodiments stated herein. On the contrary, for a person of ordinary skill in the art, these provided embodiments make the present disclosure more thoroughly, comprehensively, and completely convey the scope of the present invention.

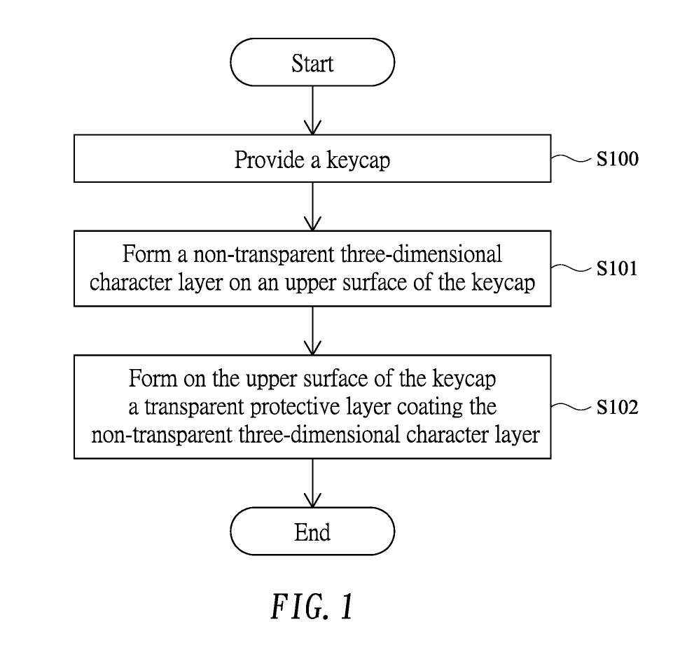

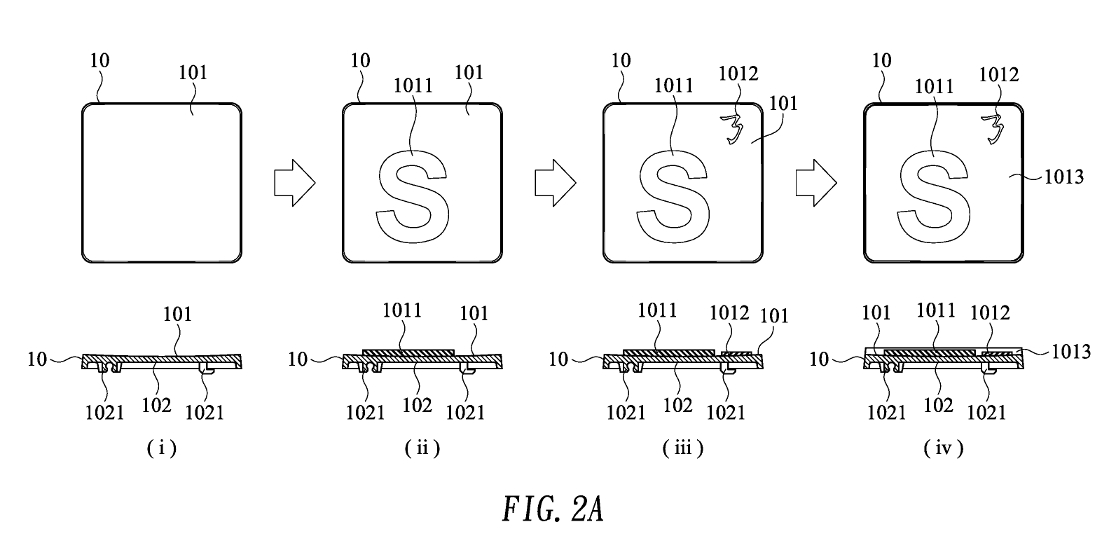

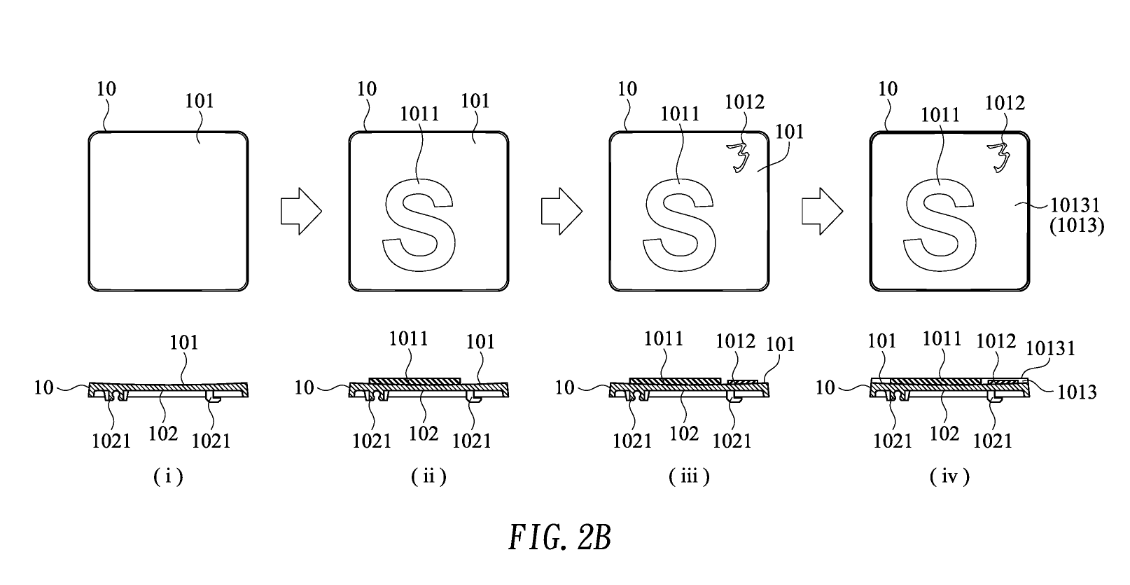

Referring to FIG. 1 and FIG. 2A, FIG. 1 is a flowchart of forming a keycap three-dimensional character according to the present invention; FIG. 2A is a schematic diagram of a first implementation of a process of forming a keycap three-dimensional character according to the present invention. First, provide a keycap 10 (step S100). In step S100, the keycap 10 has an upper surface 101 and a lower surface 102, where the lower surface 102 has a plurality of first bonding portions 1021 (as shown in (i) of FIG. 2A). The material of the keycap 10 is an acrylonitrile butadiene styrene (ABS) resin.

Then, form a non-transparent three-dimensional character layer on an upper surface 101 of the keycap 10 (step S101). In step 5101, a mold with a micro-structure (not shown in the figure) may be used to make a material such as rubber or silica gel form a non-transparent first three-dimensional character layer 1011 (as shown in (ii) of FIG. 2A) or form a non-transparent second three-dimensional character layer 1012 (as shown in (iii) of FIG. 2A) on the upper surface 101 of the keycap 10 in an injection molding manner.

At last, form on the upper surface 101 of the keycap 10 a transparent protective layer 1013 coating the non-transparent three-dimensional character layer (step S102). In step S102, the mold with a micro-structure (not shown in the figure) is also used to form the transparent protective layer 1013 coating the first three-dimensional character layer 1011 and the second three-dimensional character layer 1012 on the upper surface 101 of the keycap 10 in an injection molding manner (as shown in (iv) of FIG. 2A). The transparent protective layer 1013 coats and covers on the first three-dimensional character layer 1011 and the second three-dimensional character layer 1012, and the thickness of the first three-dimensional character layer 1011 is greater than the thickness of the second three-dimensional character layer 1012. The material of the transparent protective layer 1013 may be a UV curing adhesive (UV adhesive), acryl (Polymethylmethacrylate, PMMA), or transparent silica gel. Although the present invention provides only the implementation that the thickness of the first three-dimensional character layer 1011 is greater than the thickness of the second three-dimensional character layer 1012, in an actual application, the thickness of the non-transparent three-dimensional character layer may be adjusted according to a demand of character display of the keycap 10. For example, the thickness of the first three-dimensional character layer 1011 may be made to be less than the thickness of the second three-dimensional character layer 1012, which is not limited to the implementation provided in the present invention.

Referring to FIG. 2B, FIG. 2B is a schematic diagram of a second implementation of a process of forming a keycap three-dimensional character according to the present invention. What (i), (ii), and (iii) of FIG. 2B show is the same as what (i), (ii), and (iii) of FIG. 2A show, and details are not provided herein. However, a difference between FIG. 2B and FIG. 2A lies in that the transparent protective layer 1013 shown in (iv) of FIG. 2B coats the first three-dimensional character layer 1011 and the second three-dimensional character layer 1012 and covers on the second three-dimensional character layer 1012. On the other hand, because the thickness of the transparent protective layer 1013 is the same as the thickness of the first three-dimensional character layer 1011, the transparent protective layer 1013 does not cover on the first three-dimensional character layer 1011, and the first three-dimensional character layer 1011 may be made to be exposed from a surface of the transparent protective layer 1013 and form a coplane 10131 with the transparent protective layer 1013. Although the present invention provides only the implementation that the first three-dimensional character layer 1011 and the transparent protective layer 1013 form the coplane 10131, in an actual application, adjustment may be made according to the thickness of the non-transparent three-dimensional character layer. For example, if the thickness of the first three-dimensional character layer 1011 is equal to the thickness of the second three-dimensional character layer 1012, the first three-dimensional character layer 1011 and the second three-dimensional character layer 1012 can both be exposed from the surface of the transparent protective layer 1013 and form the coplane 10131 with the transparent protective layer 1013; if the thickness of the first three-dimensional character layer 1011 is less than the thickness of the second three-dimensional character layer 1012, the second three-dimensional character layer 1012 may be exposed from the surface of the transparent protective layer 1013 and form the coplane 10131 with the transparent protective layer 1013, which is not limited by the implementation provided in the present invention.

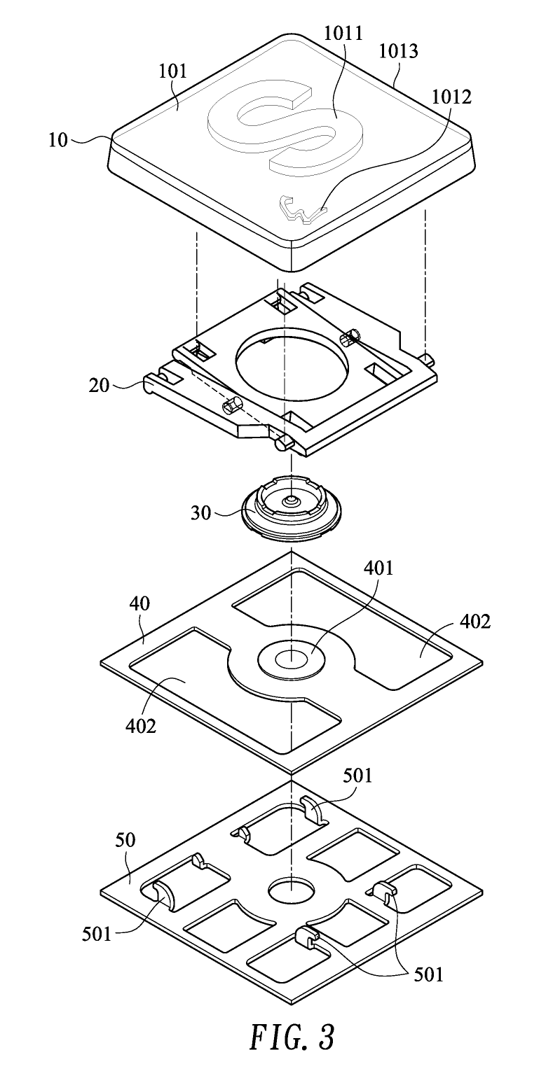

Referring to FIG. 3, FIG. 3 is a schematic three-dimensional diagram of a keyboard structure according to the present invention. In FIG. 3, the keyboard structure of the present invention includes: the keycap 10, a support component 20, an elastic component 30, a thin film layer 40, and a support plate 50. The elastic component 30 is disposed below the keycap 10, and the support component 20 encircles the elastic component 30 and is configured to connect to the keycap 10 and the support plate 50. The keycap 10 has the upper surface 101 and the lower surface 102 (as shown in FIG. 2A or 2B), and the lower surface 102 has the plurality of first bonding portions 1021 (as shown in FIG. 2A or 2B). The thin film layer 40 includes a switch 401 and an opening 402. The support plate 50 has a plurality of second bonding portions 501. In this embodiment, the upper surface 101 of the keycap 10 includes: the non-transparent first three-dimensional character layer 1011, the non-transparent second three-dimensional character layer 1012, and the transparent protective layer 1013 coating the first three-dimensional character layer 1011 and the second three-dimensional character layer 1012. The materials of the first three-dimensional character layer 1011 and the second three-dimensional character layer 1012 are: rubber or silica gel. The material of the transparent protective layer 1013 is: a UV curing adhesive, acryl, or transparent silica gel. The material of the keycap 10 is an ABS resin. The material of the elastic component 30 is rubber, silica gel, or a metal elastic piece.

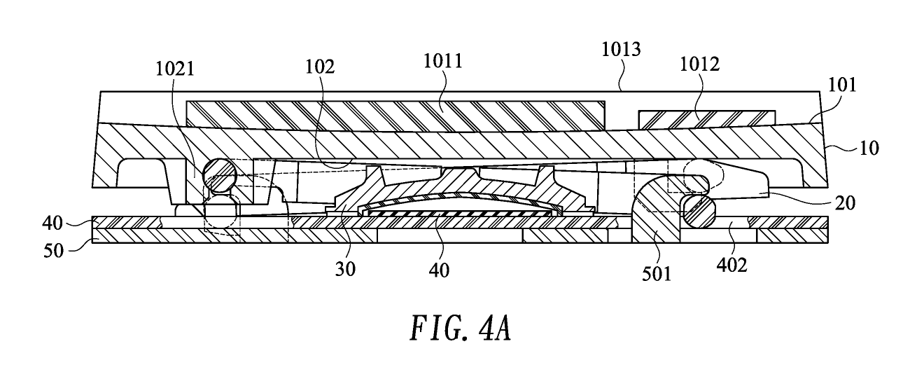

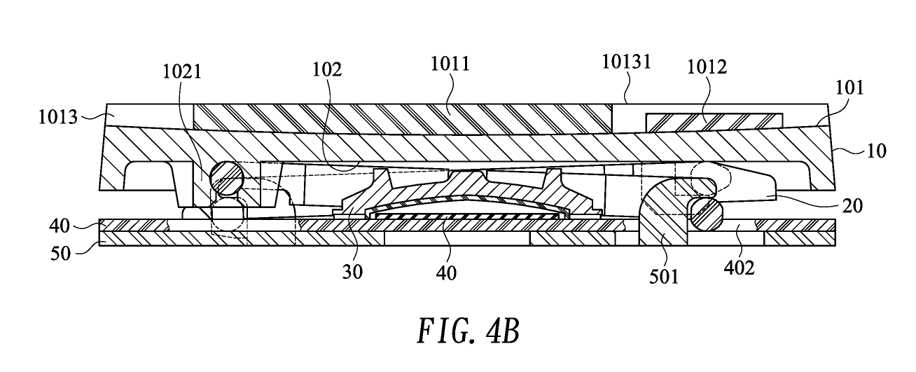

Referring to FIG. 4A, FIG. 4A is a sectional view of the first implementation of a keyboard structure according to the present invention. When keys are assembled, first, the thin film layer 40 is disposed on the support plate 50, and the second bonding portion 501 of the support plate 50 may penetrate the opening 402 of the thin film layer 40. The elastic component 30 is correspondingly disposed on the switch 401. The support components 20 may be pivotally connected to each other by using a pivotal shaft (not shown in the figure). One end of the support component 20 is pivotally connected to the first bonding portion 1021 of the lower surface 102 of the keycap 10, and the other end of the support component 20 is pivotally connected to the second bonding portion 501 of the support plate 50, so as to drive and guide the keycap 10 to perform actions of going down and up relative to the support plate 50. When the keycap 10 is pressed to go down, the elastic component 30 is deformed and contacts with the switch 401, to generate a key signal. When the keycap 10 is not pressed, the elastic component 30 also provides an upward elastic restoring force to the keycap 10, to push the keycap 10 to go up and make the keycap 10 reset. Although the present invention provides only the implementation that the support component 20 has a scissors structure, in an actual application, the support component 20 may be replaced with another support component having a similar structure, for example, a V shape, an A shape, or a structure of two parallel connecting rods, which is not limited by the implementation provided in the present invention.

Referring to FIG. 4A again, in FIG. 4A, the transparent protective layer 1013 may coat and cover on the non-transparent first three-dimensional character layer 1011 and the non-transparent second three-dimensional character layer 1012, so that the first three-dimensional character layer 1011 and the second three-dimensional character layer 1012 cannot be exposed from the surface of the transparent protective layer 1013, and the thickness of the first three-dimensional character layer 1011 is greater than the thickness of the second three-dimensional character layer 1012. In this way, the keycap 10 can make, by means of the three-dimensional first three-dimensional character layer 1011 and second three-dimensional character layer 1012, the character of the keycap 10 have a three-dimensional visual effect. Further, a three-dimensional effect of the character can be improved by means of a difference between the thickness of the first three-dimensional character layer 1011 and the thickness of the second three-dimensional character layer 1012. On the other hand, if the transparent protective layer 1013 is made of soft transparent silica gel, a sense of soft pressing touch is provided on the surface of the keycap 10, thereby improving comfort of pressing of the keyboard. Although the present invention provides only the implementation that the thickness of the first three-dimensional character layer 1011 is greater than the thickness of the second three-dimensional character layer 1012, in an actual application, the thickness may be adjusted according to a demand of character display of the keycap 10. For example, the thickness of the first three-dimensional character layer 1011 may be made to be less than the thickness of the second three-dimensional character layer 1012, which is not limited to the implementation provided in the present invention. In addition, in the present invention, the three-dimensional visual effect of the character of the keycap 10 can be improved by forming the first three-dimensional character layer 1011 or the second three-dimensional character layer 1012 having different colors or patterns.

Referring to FIG. 4B, FIG. 4B is a sectional view of the second implementation of a keyboard structure according to the present invention. In FIG. 4B, components including the support component 20, the elastic component 30, the thin film layer 40, and the support plate 50 are the same as those in FIG. 4A and are not described in detail herein. However, a difference lies in that the transparent protective layer 1013 covers the non-transparent first three-dimensional character layer 1011 and the non-transparent second three-dimensional character layer 1012 and covers on the second three-dimensional character layer 1012. Because the thickness of the transparent protective layer 1013 is the same as the thickness of the first three-dimensional character layer 1011, the transparent protective layer 1013 does not cover on the first three-dimensional character layer 1011, and the first three-dimensional character layer 1011 may be made to be exposed from the surface of the transparent protective layer 1013 and form a coplane 10131 with the transparent protective layer 1013. In this way, in addition to that the keycap 10 can make, by means of the non-transparent first three-dimensional character layer 1011 and the non-transparent second three-dimensional character layer 1012, the character of the keycap 10 have a three-dimensional visual effect, and the three-dimensional effect is improved by means of the difference between the thickness of the first three-dimensional character layer 1011 and the thickness of the second three-dimensional character layer 1012, on the other hand, when pressing the coplane 10131 of the keycap 10, a user may directly touch the first three-dimensional character layer 1011. Because the first three-dimensional character layer 1011 is made of soft rubber or silica gel, a sense of soft pressing touch is provided on the surface of the keycap 10, thereby improving comfort of pressing of the keyboard. Certainly, if the transparent protective layer 1013 is also made of soft transparent silica gel, a sense of touch and comfort when the keycap 10 is pressed can also be further improved. Although the present invention provides only the implementation that the first three-dimensional character layer 1011 and the transparent protective layer 1013 form the coplane 10131, in an actual application, adjustment may be performed according to the thickness of the non-transparent three-dimensional character layer. For example, the first three-dimensional character layer 1011 and the second three-dimensional character layer 1012 are both exposed from the surface of the transparent protective layer 1013 and form the coplane 10131 with the transparent protective layer 1013, and when pressing the coplane 10131 of the keycap 10, the user may directly touch the first three-dimensional character layer 1011 and the second three-dimensional character layer 1012; or the second three-dimensional character layer 1012 may be exposed from the surface of the transparent protective layer 1013 and form the coplane 10131 with the transparent protective layer 1013, and when pressing the coplane 10131 of the keycap 10, the user may directly touch the second three-dimensional character layer 1012, which is not limited by the implementation provided in the present invention.

In the keyboard structure provided in the present invention, compared with the conventional technology, the keycap thereof may have a three-dimensional visual effect by means of the non-transparent three-dimensional character layer. In addition, when the non-transparent three-dimensional character layer is exposed and forms the coplane with the transparent protective layer of the keycap, the keycap may be made, by means of characteristics of the material of the non-transparent three-dimensional character layer, to have a sense of soft pressing touch, thereby improving comfort of pressing of the keyboard. Therefore, the present invention is a creation having much industrial value.

Various modifications can be made to the present invention by a person skilled in the art by using common measures without departing from the protection scope of the appended claims.

What is claimed is:

1. A keyboard structure, comprising:
a keycap, having an upper surface and a lower surface;
a support plate; and
a support component, configured to connect to the keycap and the support plate, wherein
the upper surface comprises a non-transparent three-dimensional character layer and a transparent protective layer coating the non-transparent three-dimensional character layer.

2. The keyboard structure according to claim 1, wherein the thickness of the transparent protective layer is equal to the thickness of the non-transparent three-dimensional character layer, so that the non-transparent three-dimensional character layer and the transparent protective layer form a coplane.

3. The keyboard structure according to claim 1, wherein the non-transparent three-dimensional character layer comprises a first three-dimensional character layer and a second three-dimensional character layer.

4. The keyboard structure according to claim 3, wherein the thickness of the first three-dimensional character layer is equal to the thickness of the second three-dimensional character layer.

5. The keyboard structure according to claim 3, wherein the thickness of the first three-dimensional character layer is greater than the thickness of the second three-dimensional character layer.

6. The keyboard structure according to claim 3, wherein the thickness of the first three-dimensional character layer is less than the thickness of the second three-dimensional character layer.

7. The keyboard structure according to claim 1, wherein the material of the non-transparent three-dimensional character layer is rubber or silica gel.

8. The keyboard structure according to claim 1, wherein the material of the transparent protective layer is a UV curing adhesive, acryl, or transparent silica gel.

9. The keyboard structure according to claim 1, wherein an elastic component is disposed between the keycap and the support plate, and the support component encircles the elastic component.

10. The keyboard structure according to claim 9, wherein a thin film layer is disposed on the support plate, the thin film layer comprises at least one switch, and the at least one switch corresponds to the elastic component.

11. The keyboard structure according to claim 9, wherein the material of the elastic component is rubber, silica gel, or a metal elastic piece.

12. A method for forming a keycap three-dimensional character, comprising the following steps:
(a) providing a keycap;
(b) forming a non-transparent three-dimensional character layer on an upper surface of the keycap; and
(c) forming on the upper surface of the keycap a transparent protective layer coating the non-transparent three-dimensional character layer.

13. The method for forming a keycap three-dimensional character according to claim 12, wherein in step (b), the non-transparent three-dimensional character layer comprises a first three-dimensional character layer and a second three-dimensional character layer.

14. The method for forming a keycap three-dimensional character according to claim 12, wherein in step (b), the material of the non-transparent three-dimensional character layer is rubber or silica gel.

15. The method for forming a keycap three-dimensional character according to claim 12, wherein in step (c), the material of the transparent protective layer is a UV curing adhesive, acryl, or transparent silica gel.
